(19) United States
(12) Patent Application Publication
(10) Pub. No.: US 2024/0166471 A1
(43) Pub. Date: May 23, 2024

(54) MONITORING ELEVATOR DOOR OPERATION

(71) Applicant: KONE Corporation, Helsinki (FI)

(72) Inventors: Matti LIN, HELSINKI (FI); Petri KUISMA, HELSINKI (FI)

(73) Assignee: KONE Corporation, Helsinki (FI)

(21) Appl. No.: 18/429,617

(22) Filed: Feb. 1, 2024

Related U.S. Application Data
(63) Continuation of application No. PCT/EP2021/072996, filed on Aug. 19, 2021.

(51) Int. Cl. B66B 13/22; B66B 13/16

(52) U.S. Cl. CPC B66B 13/22; B66B 13/16

(57) ABSTRACT

An apparatus for monitoring operation of a locking mechanism applied for securing an elevator door to a closed position is provided, where said monitoring is carried out via monitoring operation of a door driving system arranged for driving movement of the elevator door between the closed position and an open position. The apparatus is arranged to: receive one or more parameters that are descriptive of movement of the elevator door from the closed position towards the open position; determine, based on said one or more parameters, a door movement profile that is descriptive of an aspect of movement of the elevator door in relation to the closed position of the elevator door; and detect compromised operation of the locking mechanism based on one or more characteristics of the door movement profile within a portion thereof that represents a predefined traveling distance in relation to the closed position of the elevator door.

### TECHNICAL FIELD

The example and non-limiting embodiments of the present invention relate to monitoring elevator door operation.

### BACKGROUND

Correct operation of elevator doors is an important aspect in terms of safety and convenience of elevator passengers. In particular, timely opening the doors to enable passengers to enter and exit an elevator car plays an important role in avoiding undue delays in passenger transport, while ensuring that doors can be opened when the elevator car is in a position that enables safe movement between the elevator and a landing of the elevator system and ensuring that are doors remain closed when the elevator car is in transit between landings is an important aspect of passenger safety.

In many elevator systems the elevator doors are automatically operated such that opening and closing the elevator doors is carried out via using a driving system arranged in the elevator car, which driving system comprises an electric motor arranged to drive movement of the elevator doors under control of an elevator door controller. An elevator door is typically further provided with a locking mechanism that ensures keeping the elevator door closed when the elevator car is in transit between landings and that allows for opening the elevator door when the elevator car is positioned at a landing zone of a landing.

Correct and reliable operation of the locking mechanism is hence critical for safe operation of the elevator system. The locking mechanism is typically configured or calibrated upon manufacturing, installing or carrying out a maintenance operation to the elevator car such that it ensures keeping the elevator door closed when the elevator car is in transit between landings and allows for opening the elevator door when the elevator car is positioned at a landing zone. However, due to wear and tear of components associated with the elevator door as well as due to dust, dirt, etc. accumulating to the components associated with the elevator door, prolonged operation of the elevator car may result in compromised operation or even a malfunction of the locking mechanism and, consequently resulting in compromised elevator door operation. Since malfunction of the locking mechanism such that it fails to keep the elevator door closed during transit and/or such that it fails to open the elevator door when the elevator car stops at a landing may seriously compromise passenger safety, early detection of possibly compromised operation of the locking system would be advantageous.

### SUMMARY

It is an object of the present invention to provide a technique that facilitates detection of compromised operation of a locking mechanism of an elevator door.

According to an example embodiment, an apparatus for monitoring operation of a locking mechanism applied for securing an elevator door to a closed position is provided, where said monitoring is carried out via monitoring operation of a door driving system arranged for driving movement of the elevator door between the closed position and an open position, the apparatus arranged to: receive one or more parameters that are descriptive of movement of the elevator door from the closed position towards the open position; determine, based on said one or more parameters, a door movement profile that is descriptive of an aspect of movement of the elevator door in relation to the closed position of the elevator door; and detect compromised operation of the locking mechanism based on one or more characteristics of the door movement profile within a portion thereof that represents a predefined traveling distance in relation to the closed position of the elevator door.

According to another example embodiment, an elevator car for vertical movement within an elevator shaft of an elevator system between a first landing and at least one further landing is provided, the elevator car comprising: a car door that is moveable between an open position and a closed position; a door driving system for driving movement of the car door between the open and closed positions; and a door controller for controlling operation of the door driving system and for monitoring operation of a locking mechanism applied for securing an elevator door to the closed position, wherein the door controller is arranged to: receive one or more parameters that are descriptive of movement of the elevator door from the closed position towards the open position, determine, based on said one or more parameters, a door movement profile that is descriptive of an aspect of movement of the elevator door in relation to the closed position of the elevator door, and detect compromised operation of the locking mechanism (141, 145) based on one or more characteristics of the door movement profile within a portion thereof that represents a predefined traveling distance in relation to the closed position of the elevator door.

According to another example embodiment, a method for monitoring operation of a locking mechanism applied for securing an elevator door to a closed position is provided, where said monitoring is carried out via monitoring operation of a door driving system arranged for driving movement of the elevator door between the closed position and an open position, the method comprising: receiving one or more parameters that are descriptive of movement of the elevator door from the closed position towards the open position, determining, based on said one or more parameters, a door movement profile that is descriptive of an aspect of movement of the elevator door in relation to the closed position of the elevator door, and detecting compromised operation of the locking mechanism based on one or more characteristics of the door movement profile within a portion thereof that represents a predefined traveling distance in relation to the closed position of the elevator door.

According to another example embodiment, a computer program is provided, the computer program comprising computer readable program code configured to cause performing at least the method according to the example embodiment described in the foregoing when said program code is executed on one or more computing apparatuses.

The computer program according to the above-described example embodiment may be embodied on a volatile or a non-volatile computer-readable record medium, for example as a computer program product comprising at least one computer readable non-transitory medium having the program code stored thereon, which, when executed by one or more computing apparatuses, causes the computing apparatuses at least to perform the method according to the example embodiment described in the foregoing.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1A schematically illustrates some aspects of an elevator system according to an example;

FIG. 1B illustrates a block diagram of some logical elements of an elevator control system according to an example;

FIG. 2 schematically illustrates some elements of a locking mechanism according to an example;

FIG. 3 schematically illustrates a reference power consumption profile according to an example;

FIG. 4 schematically illustrates a power consumption profile according to an example;

FIG. 5 illustrates a method according to an example; and

FIG. 6 illustrates a block diagram of some elements of an apparatus according to an example.

### DESCRIPTION OF SOME EMBODIMENTS

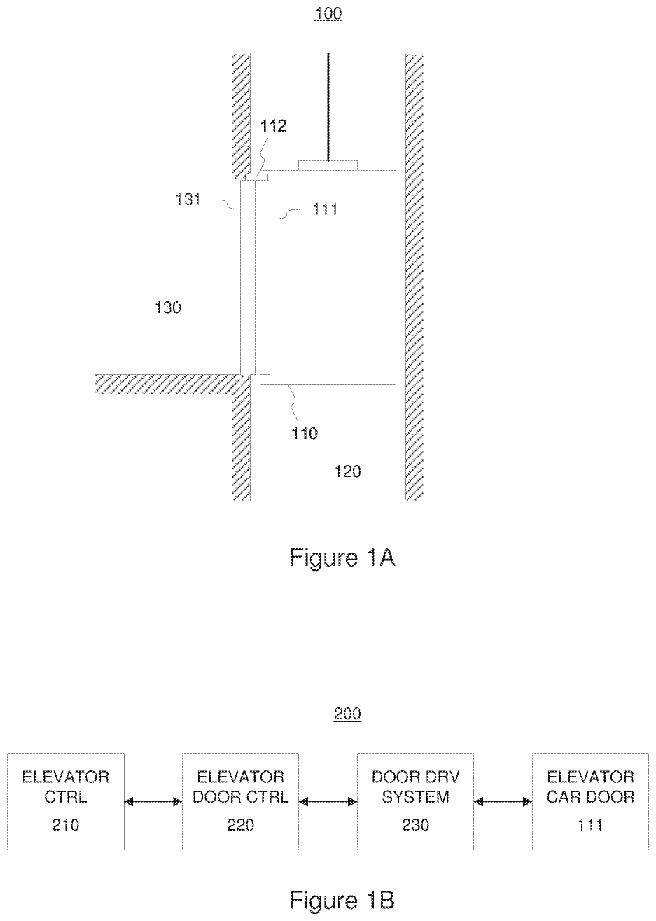

FIG. 1A schematically illustrates some aspects of an elevator system 100 provided with automatic doors according to an example, including an elevator car 110 that may be moved in the vertical direction within an elevator shaft 120 to enable transporting passengers and/or cargo between landings of the elevators system 100. The elevator system 100 may comprise at least two landings, while a landing 130 shown in the schematic illustration of FIG. 1A serves to represent any landing of the elevator system 100. The elevator car 110 may be provided with a car door 111, wherein the car door 111 comprises a sliding door that may is moveable between a closed position and an open position. The elevator car 110 may further comprise a door coupler 112 connected to the car door 111 for temporarily coupling the car door 111 to a landing door 131 of the landing 130 when the elevator car 110 resides within the landing zone of the landing 130 such that when moving the car door 111 the landing door 131 moves between a closed position and an open position together with the car door 111, thereby allowing passengers to move between the landing 130 and the elevator car 110 when the elevator car 110 is at the landing 130 while preventing the passengers from entering the elevator shaft 120 when the elevator car 110 is not at the landing 130.

The door coupler 112 may comprise coupling elements that engage corresponding counter elements in the landing door 131 upon moving the car door 111 when the elevator car 110 resides within the landing zone of the landing 130, thereby coupling the landing door 131 with the car door 111. In this regard, the coupling elements in the door coupler 112 and the counter elements in the landing door 131 are positioned with respect each other such that, when the elevator car 110 is moving along the elevator shaft 120 past the landing door 131, the coupling elements are passed between the coupling elements. When the elevator car 110 is at the landing 130 and the car door 111 is moved in order to open the car door 111, the coupling elements of the door coupler 112 in the elevator car 110 engage the counter elements in the landing door 131 and, consequently, when the car door 111 is moved by a door driving system arranged in the elevator car 110, the landing door 131 moves together with the car door 111.

In an example, the coupling elements may be arranged in a (first) railing assembly provided in the elevator car above the car door 111 for guiding the movement of the car door 110 between the open and closed positions, whereas the counter elements may be arranged in a (second) railing assembly provided in the landing above the landing door 131 for guiding the movement of the landing door 131 between the open and closed positions. As an example in this regard, the coupling elements may comprise coupling vanes (provided e.g. as sheet-metal vanes) projecting from the door coupler 112 towards the landing door 131, where the coupling vanes may be arranged such that they form a vertical ‘slot’ that has its open end directed towards the landing door 131, whereas the counter elements may comprise one or more rollers mounted on the landing door 131 in a position projecting from the landing door 131 towards the elevator shaft 120, the respective axes of the one or more rollers being substantially perpendicular to the plane of the landing door 131.

FIG. 1B illustrates a block diagram of some logical elements of an elevator control system 200 according to an example. The elevator control system 200 may serve to control various aspect related to movement and operation of the elevator car 110. In this example, the elevator control system 200 is shown with an elevator controller 210 for controlling at least some aspects of movement of the elevator car 110 in the elevator shaft 120, a door driving system 230 for driving movement of the car door 111 of the elevator car 110 between a closed position and an open position; and a door controller 220 for operating the door driving system 230 and for monitoring at least one aspect of operation of the door driving system 230.

Along the lines described in the foregoing, the elevator controller 210 may be arranged to control at least some aspects of movement of the elevator car 110 in the elevator shaft 120. The elevator controller 210 is typically installed outside the elevator car 110, for example in suitable location in the elevator shaft 120 or in its close proximity, and it may comprise or may be provided using one or more computing devices comprising respective one or more processors arranged to execute one or more computer programs to provide at least some aspects of operation of the elevator controller 210. Hence, the elevator controller 210 may be provided as an elevator control apparatus (e.g. using a single computer apparatus) or as an elevator control system (e.g. using one or more computer apparatuses). The elevator controller 210 is communicatively coupled to the door controller 220, where the communicative coupling between the elevator controller 210 and the door controller 220 may be provided using a wired communication network or communication link, using a wireless communication network or communication link, or using a combination of a wireless communication network or communication link and a wireless communication network or communication link. The elevator controller 210 may be further communicatively coupled to one or more further elevator controllers that may be arranged for controlling at least some aspect of movement of respective elevator cars in other elevator shafts and/or to an elevator group controller arranged to control at least some aspects related to movement of a plurality of elevator cars in a plurality of elevator shafts.

Operation of the elevator controller 210 in terms of controlling movement of the elevator car 110 may involve, for example, controlling the speed of the elevator car 110 via control of one or more electric motors arranged for driving the elevator car 110 and controlling braking system arranged to regulate the speed of the elevator car 110. In context of the present disclosure, however, aspects of specific interest pertain to operation of the door controller 220 in controlling and monitoring movement of the car door 111 and/or the landing door 131 and, consequently, any further details pertaining to the operation of the elevator controller 210 and/or movement of the elevator car 110 along the elevator shaft 120 are described herein only to extent they are necessary for describing examples that pertain to said certain aspects of operation of the door controller 220. In this regard, aspects related to general operation of the elevator controller 210 in controlling movement of the elevator car 110 along the elevator shaft 120 may be provided using techniques known in the art.

Along the lines described in the foregoing, the door driving system 230 may be arranged to drive movement of the car door 111 between the closed position and the open position. In this regard, the door driving system 230 may operate under control of the door controller 220, e.g. in accordance with one or more door control signals received from the door controller 220. The door driving system 230 may comprise an electric motor and a motor controller arranged to control operation of the electric motor that is coupled to the car door 111 via a transmission system such that operation of the electric motor causes linear movement of the elevator car door 111 in a direction that is substantially parallel with an opening in a wall of the elevator shaft 120 at the landing 130, thereby enabling movement of the car door 111 between the closed and open positions. The transmission system may be arranged to convert the rotary motion provided by the electric motor into the linear movement of the car door 111. Characteristics of the transmission system may be selected in accordance with requirements of a specific implementation of the elevator car 110, the car door 111 and/or the door driving system 230, and the transmission system may involve, for example, one or more of the following: a belt drive, a chain drive, a gear train.

The door controller 220 is typically installed in the elevator car 110, for example in suitable location in the interior of the elevator car 110 (e.g. in a ceiling structure of the elevator car 110) or on the exterior of the elevator car 110 (e.g. on the roof of the elevator car 110). The door controller 220 may comprise or may be provided using a computing device comprising one or more processors arranged to execute one or more computer programs to provide at least some aspects of operation of the door controller 220. Hence, the door controller 220 may be provided as a door controller apparatus. Along the lines described in the foregoing, the door controller 220 is communicatively coupled to the elevator controller 210, whereas the door controller 220 is further communicatively coupled to the door driving system 230, where the communicative coupling between the door controller 220 and the door driving system 230 may be provided using a wired or wireless communication network and/or communication link.

The aspect of the door controller 220 controlling the movement of the car door 111 between the closed and open positions may comprise at least the following operations with respect to moving the elevator car door 111:
move the car door 111 in a first direction to open the car door 111,
move the car door 111 in a second direction that is opposite of the first direction to close the car door 111.

Each of these operations may be effected via the door controller 220 issuing a respective control signal to the door driving system 230. The door controller 220 may further enable, for example, setting and/or adjusting movement speed of the car door 111 via application of a respective control signal.

Referring back to the aspect of moving the car door 111 between the open and closed positions, the car door 111 and/or the landing door 130 may be provided with a (respective) locking mechanism for locking and unlocking the car door 111 and/or the landing door 131. The locking mechanism for the car door 111 may be applied to keep the car door 111 locked when the elevator car 110 is moving along the elevator shaft 120 between landings of the elevator system 100 and to keep the car door 111 unlocked when elevator car 110 is positioned at any of the landings of the elevator system 100. The locking mechanism for the landing door 131 may be applied to keep the landing door 131 locked when the elevator car 110 is not positioned at the landing 130 and to keep the landing door 131 unlocked when the elevator car 110 is positioned at the landing 130.

In various examples in this regard, the locking mechanism for the car door 111 may be applied to unlock the car door 111 upon the elevator car 110 entering a landing zone of a landing of the elevator system 100, upon the elevator car 110 stopping at the respective landing, or in the course of a procedure for opening the car door 111 via operation of the door driving system 230, whereas the locking the car door 111 may be carried out e.g. in the course of a procedure for closing the car door 111, upon the elevator car 110 leaving the respective landing, or upon the elevator car 110 exiting the landing zone of the respective landing. Along similar lines, the locking mechanism for the landing door 131 may be applied to unlock the landing door 131 upon the elevator car 110 entering the landing zone of the landing 130, upon the elevator car 110 stopping at the landing 130, or in the course of a procedure for opening (the car door 111 and) the landing door 131 via operation of the door driving system 230, whereas locking the landing door 131 may be carried out e.g. in the course of a procedure for closing (the car door 111 and) the landing door 131, upon the elevator car 110 leaving the landing 130, or upon the elevator car 110 exiting the landing zone of the landing 130.

In the following examples, where applicable, the term elevator door 111, 131 is applied to refer to one or both of the car door 111 and the landing door 131 as an editorial choice made in the interest of ensuring clarity and brevity of description via avoidance of extensive repetition of the terms car door 111 and landing door 131 throughout the examples.

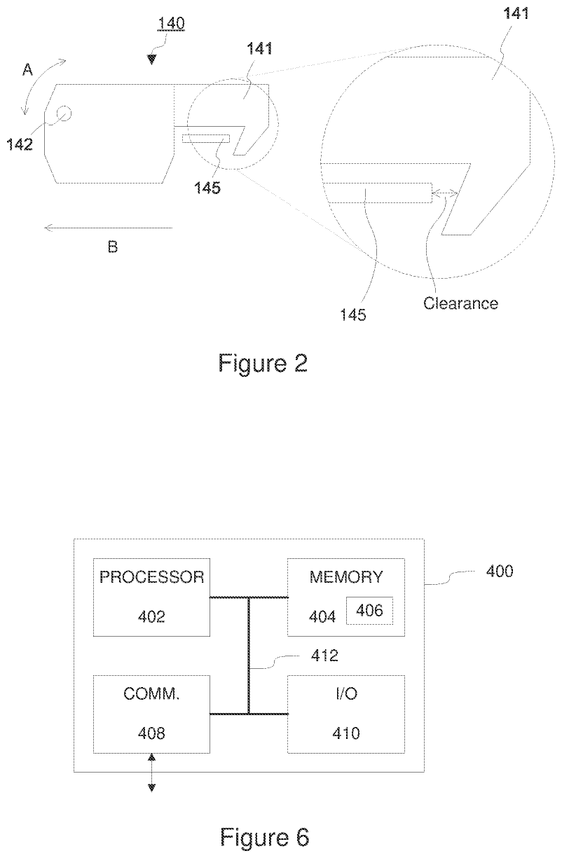

FIG. 2 schematically illustrates a locking mechanism according to an example, where the locking mechanism comprises a lock hook assembly 140 for arrangement in the elevator door 111, 131 and a lock latch 145 for arrangement in a frame of the elevator door 111, 131. The lock latch 145 may be also referred to as a lock counterpart. The lock hook assembly 140 may be rotatable about an axis 142 (as indicated by the curved arrow A) and it may comprise a lock hook portion 141 for engaging the lock latch 145. The lock hook assembly 140 and the lock latch 145 may be installed with respect to each other such that when the elevator door 111, 131 is in the closed position, the lock hook portion 141 may be brought via a rotating movement of the lock hook assembly 140 in a first direction (e.g. in the clockwise direction as in the illustration of FIG. 2) into a position where it engages the lock latch 145, whereas the lock latch 145 may be disengaged from the lock hook portion 141 via a rotating movement of the lock hook assembly 140 in a second direction that is the opposite of the first direction (e.g. the counter-clockwise direction as in the illustration of FIG. 2).

The locking mechanism may further comprise a lock hook actuation assembly (not shown in the illustration of FIG. 2) for rotating the lock hook assembly 140 by a predefined amount in the first direction such that the lock hook portion 141 engages the lock latch 145 in response to moving the elevator door 111, 131 to the closed position (e.g. against the direction indicated by the arrow B in FIG. 2) and for rotating the lock hook assembly 140 by the predefined amount in the second direction such that the lock latch 145 is disengaged from the lock hook portion 141 in response to moving the elevator door 111, 131 from the closed position towards the open position (e.g. to the direction indicated by the arrow B in FIG. 2). The lock hook actuation assembly may be provided using a suitable mechanical or electromechanical arrangement known in the art. As an example in this regard, the door coupler 112 may further serve as the lock hook actuation assembly such that operation of the door coupler 112 to couple the landing door 131 to the car door 111 upon starting to move the elevator door 111, 131 from the closed position towards the open position further serves to rotate the lock hook assembly 140 in the second direction (to cause disengaging the lock latch 145 from the lock hook portion 141) and such that operation of the door coupler 112 to uncouple the landing door 131 from the car door 111 after having brought the elevator door 111, 131 to the closed position further serves to rotate the lock hook assembly 140 in the first direction (to cause the lock hook portion 141 engaging the lock latch 145).

The locking mechanism may further comprise a locking member (not shown in the illustration of FIG. 2) for locking and unlocking the elevator door 111, 131. The locking member may be provided using a suitable mechanical or electromechanical arrangement known in the art. According to an example, the locking member (e.g. a locking pin) may be arranged to selectively disable or enable rotation of the lock hook assembly 140 under control of a control signal issued by the elevator door controller 220, thereby enabling locking the elevator door 111, 131 via disabling rotation of the lock hook assembly 140 and unlocking the elevator door 111, 131 via enabling rotation of the lock hook assembly 140. In another example, the locking member may be arranged to selectively disable or enable operation of the lock hook actuation assembly, thereby enabling locking the elevator door 111, 131 via disabling operation of the lock hook actuation assembly to rotate the lock hook assembly 140 and unlocking the elevator door 111, 131 via enabling operation of the lock hook actuation assembly to rotate the lock hook assembly 140.

As pointed out above, the illustration of FIG. 2 is a schematic one that serves to illustrate the operating principle of the exemplifying locking mechanism applicable for locking and unlocking the elevator door 111, 131 where the lock hook portion 141 of the lock hook assembly 141 may be caused to engage or disengage the lock latch 145 via the rotating movement of lock hook assembly 140. In this regard, the respective shapes and sizes of the lock hook assembly 140 and the lock latch 145, their arrangement with respect to each other as well as their orientation and/or position with respect to the elevator door 111, 131 may differ from that described with references to the illustration of FIG. 2 without departing from the scope of the present disclosure as far as their positions with respect to each other may be adjusted such that locking to prevent opening of the elevator door 111, 131 and unlocking to enable opening of the elevator door 111, 131 are provided for.

While the locking mechanism according to the example described above involves a relatively simple mechanical structure that serves as a proven solution for locking the elevator door 111, 131, it needs to be carefully calibrated in terms of lock clearance, i.e. in terms of the clearance between the lock hook portion 141 and the lock latch 145 (as illustrated in FIG. 2), to ensure reliable operation. In this regard, a sufficient lock clearance ensures undisturbed movement of the lock hook portion 141 with respect to the lock latch 145 without a contact between the two when rotating the lock hook assembly 140 while still ensuring locking that substantially prevents opening the elevator door 111, 131 without rotating the lock hook assembly 140. In contrast, less than sufficient lock clearance results in a contact between the lock hook portion 141 and the lock latch 145 upon rotating the lock hook assembly 140, which risks the lock hook portion 141 getting stuck with the lock latch 145 and, consequently, preventing opening of the elevator door 111, 131 even when unlocked. This, in turn, runs a risk of preventing passengers from entering or exiting the elevator car 110 upon arrival at the landing 130, where especially the latter may be considered to constitute a serious risk for convenience and safety of passengers.

The lock clearance may be calibrated to a reference value, for example, upon installing components of the elevator system 100 that have a direct or indirect effect on movement of the elevator door 111, 131 or upon carrying out a maintenance operation that may have an effect on respective positions of the car door 111 and the landing door 131 with respect to each other and/or with respect to the elevator car 110, thereby ensuring sufficient lock clearance and, consequently, reliable opening and closing of the elevator door 111, 131 at the landing 130. However, over time, the wear and tear of components of the elevator car 110, the car door 111 and/or the landing door 131 as well as sand, dust, dirt, etc. accumulating to the components of the elevator car 110, the car door 111, the landing door 131 and/or to the landing may result in a situation where the lock clearance (upon closing the elevator door 111, 131) is smaller than the reference value set upon calibration. Such a scenario, in turn, may result in the jamming the locking mechanism due to contact between the lock hook portion 141 and the lock latch 145 upon rotary motion of the lock hook assembly 140.

Referring now back to the door controller 220, in addition to controlling movement of the elevator door 111, 131 via controlling operation of the door driving system 230, the door controller 220 may be further arranged to monitor at least one aspect of movement of the elevator door 111, 131. This may be carried out, for example, via monitoring at least one aspect of operation of the door driving system 230 in moving the elevator door 111, 131. In this regard, the door controller 220 may receive and/or derive one or more parameters that are descriptive of aspects of the movement and/or position of the elevator door 111, 131, e.g. one or more of the following:
position of the elevator door 111, 131, e.g. in terms of the door position with respect to the (fully) open position and/or with respect to the (fully) closed position,
movement speed of the elevator door 111, 131,
power consumption of the electric motor of the door driving system 230 serving to drive movement of elevator door 111, 131,
torque of the electric motor of the door driving system 230 serving to drive movement of the elevator door 111, 131.

The position of the elevator door 111, 131 may be derived, for example, via monitoring a position of a component of the transmission system of the door driving system 230, which position is at least indirectly indicative of the (relative) position of the elevator door 111, 131 with respect to its open and closed positions. As an example in this regard, in case the transmission system of the door driving system 230 comprises a belt drive assembly, the measure of interest may comprise a position of (a predefined reference point in) a driving belt of the belt drive assembly and/or the traveling distance of the driving belt with respect to the fully closed or fully open position of the elevator door 111, 131. The movement speed of the elevator door 111, 131 may be derived, for example, via observing a time series of (at least two) positions of the elevator door 111, 131 over a time window.

The power consumption of the electric motor of the door driving system 230 may be monitored, for example, via directly monitoring a measure of power consumption of the electric motor or via monitoring one or more parameters that are indirectly descriptive of the power consumption of the electric motor. Examples of the latter include electric current and/or voltage supplied to the electric motor of the door driving system 230, e.g. the magnitude and/or phase of the electric current and/or the voltage supplied to the electric motor. Respective indications of characteristics of the electric current and/or the voltage supplied to the electric motor may be obtained, for example, from the motor controller or from respective measurement arrangements applied for measuring the electric current and/or the voltage supplied to the electric motor. Along similar lines, an indication of the torque of the electric motor may be obtained, for example, from the motor controller or from a monitoring arrangement applied for measuring the torque of the electric motor.

The aspect of the door controller 220 monitoring of at least one aspect of movement of the elevator door 111, 131 may comprise the door controller 220 reading, receiving or deriving, upon using the door driving system 230 to open the elevator door 111, 131, respective values for the one or more parameters that are descriptive of movement of the elevator door 111, 131 according to a predefined schedule, e.g. at predefined time intervals. As an example in this regard, predefined time interval may be chosen from the range from 10 to 100 milliseconds, e.g. 50 milliseconds.

According to an example, the door controller 220 may be arranged to monitor operation of the locking mechanism via observing power consumption of the electric motor of the door driving system 230 as a function of door position when moving the elevator door 111, 131 from the closed position towards the open position. In an example, this may be accomplished via deriving, based on respective values of one or more parameters that are descriptive of movement of the elevator door 111, 131 (e.g. the position of the elevator door 111, 131 and the power consumption of the electric motor) over a time period that corresponds to movement of the elevator door 111, 131 from the closed position towards the open position, a power consumption profile that is descriptive of the power consumption of the electric motor as a function of door position. In this regard, observation of the power consumption profile may be carried out in an attempt to detect an (early) indication of a loss of sufficient lock clearance, which may be detected as increased power consumption in a certain portion of the power consumption profile, as described in the following examples in further detail.

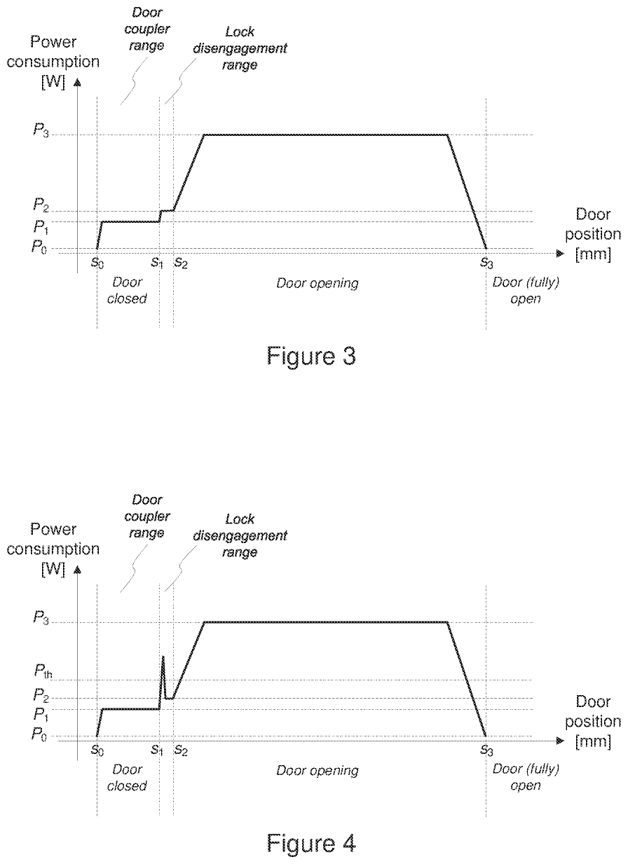

FIG. 3 illustrates a curve that represents an outline of a reference power consumption profile according to an example, where the reference power consumption profile represents power consumption of the electric motor with properly calibrated locking mechanism having a sufficient lock clearance. Therein, a portion of the curve from position s₀ to position s₁ represents a door coupler range during which the power consumption remains approximately at P₁, i.e. it represents a movement induced by the door driving system 230 (e.g. movement of the driving belt therein) that results in the landing door 131 coupling to the car door 111 due to operation of the door coupler 112 but that does not yet start opening the elevator door 111, 131. A portion of the curve from position s₁ to position s₂ represents the movement that actually moves the elevator door 111, 131 from the closed position towards the open position.

Therein, a sub-range of positions from position s₁ to position s₂ represents a lock disengagement range, which comprises a predefined range of door positions from the closed position towards the open position and hence represents a predefined traveling distance of the elevator door 111, 131 from the closed position towards the open position. In the lock disengagement range the power consumption is increased from approximately to P₁ to approximately P₂, whereas a sub-range of positions from position s₂ to position s₃ the power consumption further increases to P₃ for swiftly moving the elevator door 111, 131 to the (fully) open position. In the range from positions s₂ to s₃ the increased power consumption predominantly results from increased movement speed of the elevator door 111, 131 (where power consumption is substantially directly proportional to the movement speed of the elevator door 111, 131). The increase in power consumption to approximately P₂ in the lock disengagement range is caused by the increase in load in moving the elevator door 111, 131 due to the lock latch 145 disengaging from the lock hook portion 141 upon starting to move the elevator door 111, 131 from the closed position towards the open position.

FIG. 4 illustrates a curve that represents an outline of power consumption profile that suggests compromised lock clearance in the locking mechanism according to an example. The curve of FIG. 4 is similar to the curve of FIG. 3 except for different shape of the power consumption curve in the lock disengagement range: instead of substantially step-wise increase in power consumption from P₁ to P₂ the power consumption in the beginning of the lock disengagement range temporarily increases to a value substantially above P₂ before dropping to approximately P₂. Such a relatively sharp increase (e.g. a peak) in power consumption serves as an indication of an increased load during the lock latch 145 being disengaged from the lock hook portion 141, which in turn suggests unexpected friction between these two components due to a compromised clearance therebetween.

It is worth noting that the reference power consumption profile of FIG. 3 and the power consumption profile of FIG. 4 are respective simplified illustrations of respective power consumption profiles occurring in a real-life implementation of the elevator system 100 described in the present disclosure, while a key aspect involves characteristics of a change in power consumption resulting from the lock latch 145 disengaging from lock hook portion 141 upon the elevator door 111, 131 starting to move from the (fully) closed position toward the open position. Hence, in a real implementation the power consumption within the door coupler range (from position s₀ to position s₁) is typically not constant (at approximately at P₁) but it may rather vary within a respective range around P₁ or approximate a respective predefined curve, the power consumption within the lock disengagement range (from position s₁ to position s₂) is typically not constant (at approximately at P₂) but it may rather vary within a respective range around P₂ or approximate a respective predefined curve, while the power consumption P₃ during the elevator door 111, 131 moving from the closed position towards the open position (from position s₂ to position s₃) is likewise non-constant (at approximately at P₃) but it may rather vary within a respective range around P₃ or approximate a respective predefined curve.

The respective illustrations of FIGS. 3 and 4 show the lock disengagement range as a portion of the respective power consumption profile that follows the door coupler range, thereby covering a range of door positions starting from a door positions where the elevator door 111, 131 starts opening in the sense of providing an opening between interior of the elevator car 110 and the landing 130. In another example, the lock disengagement range may constitute a sub-range of the door coupler range. In other words, in such an example the door coupler range may cover door positions from s₀ to s₂, where the lock disengagement range covers door positions from s₁ to s₂ at the end of the door coupler range, thereby covering door positions ending to the door position where the elevator door 111, 131 starts opening in the sense of providing an opening between interior of the elevator car 110 and the landing 130. In this regard, the position of the lock disengagement range within or after the door coupler range of the respective power consumption curve depends on implementation of the lock hook actuation assembly for rotating the lock hook assembly 140 upon moving the elevator door 111, 131 from the closed position towards the open position.

In a real-life implementation, the lock clearance reducing over time may eventually lead to a situation where a contact the lock hook portion 141 and the lock latch 145 occurs upon rotating the lock hook assembly 140. In this regard, the amount friction resulting from the contact between the lock hook portion 141 and the lock latch 145 upon rotation of the lock hook assembly 140, and hence the power required for rotating the lock hook assembly 140, increases with reducing lock clearance. While a small amount of friction does not compromise operation of the locking mechanism and still allows for opening the elevator door 111, 131, seriously compromised lock clearance may result in the lock hook portion 141 getting stuck with the lock latch 145 upon the rotative movement of the lock hook assembly 140, thereby preventing opening the elevator door 111, 131 even if the power supply to the electric motor of the door driving system 230 would be increased to its maximum allowable value. While such a situation may be harmful due to possibly resulting in damage to the electric motor due to overload, it may also result in a failure in opening the elevator door 111, 131, hence possibly trapping passengers inside the elevator car 110. However, typically the lock clearance reduces gradually over time due to the wear and tear and sand, dust, dirt etc. accumulating in the structures of the elevator car 110 and/or the landing 130 affecting the operation of the elevator door 111, 113, which allows for early detection of reducing lock clearance via monitoring of the power consumption of the door driving system 230 upon opening the elevator door 111, 131.

Referring back to the power threshold Pₜₕ illustrated in FIG. 4, the power threshold Pₜₕ may represent a threshold between allowable and unallowable amount of friction between the lock hook portion 141 and the lock latch 145 upon rotating the lock hook assembly 140, hence representing a threshold between sufficient and insufficient lock clearance. In this regard, a suitable selection of the power threshold Pₜₕ enables early detection of increased friction in the locking system that serves as a sign of compromised lock clearance before the loss of clearance reaches an extent that risks the lock hook portion 141 getting stuck with the lock latch 145. An applicable value for the power threshold Pₜₕ may be defined, for example, via an experimental procedure that involves measuring respective power consumption values for a plurality of different lock clearances, identifying a lock clearance that results in a strongest allowable contact between the lock hook portion 141 and the lock latch 145, and apply the power consumption value measured for the identified lock clearance as the power threshold Pₜₕ in subsequent operation of the door controller 220.

In the illustration of FIG. 4 the predefined threshold power Pₜₕ is shown as an absolute power supplied to the electric motor of the door driving system 230 that remains constant over the lock disengagement range. In various examples, the power threshold Pₜₕ may be defined as an absolute power supplied to the electric motor or as a difference to the corresponding position or point (in terms of door position) of the reference power consumption profile. Concerning the latter example, the difference to the reference power consumption profile may be defined e.g. as a maximum allowable (absolute) difference to the power consumption indicted for the corresponding door position in the reference power consumption profile or as a maximum allowable ratio of actual (e.g. measured or estimated) power consumption to the power consumption indicted for the corresponding door position in the reference power consumption profile.

Along the lines described in the foregoing, the power consumption of the electric motor of the door driving system 230 may be monitored directly or indirectly, whereas an example of the latter involves monitoring electric current supplied to the electric motor. Hence, in an example where the power consumption of the electric motor is monitored via observing electric current supplied thereto, the power threshold Pₜₕ may be defined as a corresponding current threshold. An applicable current threshold may be determined in a manner similar to that described in the foregoing for determination of the power threshold Pₜₕ, mutatis mutandis.

In the foregoing, the examples that pertain monitoring operation of the locking mechanism applied for securing the elevator door 111, 131 to the closed position are described with references to using the one or more parameters that are descriptive of movement of the elevator door 111, 131 via operation of the door driving system 230 to determine the power consumption profile and detecting possibly compromised operation of the locking mechanism via observing the power consumption profile upon opening the elevator door 111, 131. This is, however, a non-limiting example that generalizes into using said one or more parameters to determine a door movement profile that is descriptive of an aspect of door movement as a function of door position and using the door movement profile and detecting possibly compromised operation of the locking mechanism via observing the power consumption profile upon opening the elevator door 111, 131. In other examples, the door movement profile may be descriptive of door movement speed as a function of door position, descriptive of a force applied to move the driving belt of the belt drive assembly applied as a transmission system in the door driving system 230 as a function of door position, descriptive of the torque of the electric motor as a function of door position, etc. In further examples, instead defining the door movement profile as a function of door position, the door movement profile may be defined as a function of time upon moving the elevator door 111, 131.

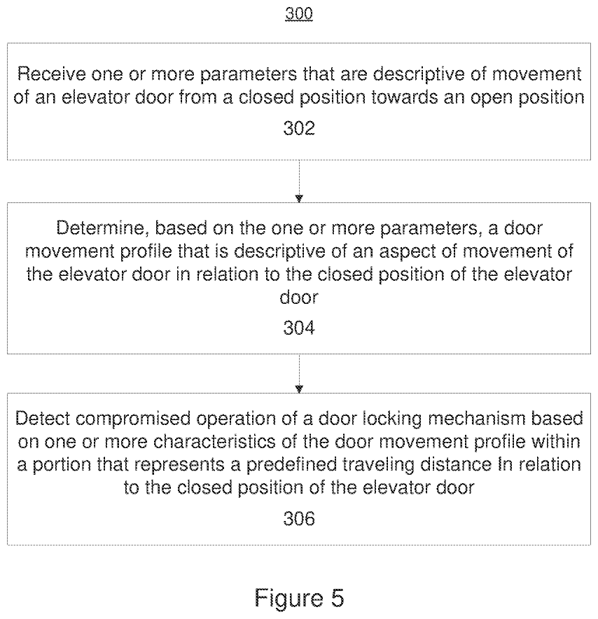

The aspect of monitoring operation of the locking mechanism via observation of the door movement profile that is descriptive of an aspect of movement of the elevator door 111, 131 may be described as steps of a method that may be carried out by the door controller 220 or by another entity of the elevator system 100. As an example in this regard, FIG. 5 illustrates a method 300 for monitoring operation of the locking mechanism applied for securing the elevator door 111, 131 to the closed position, where said monitoring is carried out via monitoring operation of the door driving system 230 arranged for driving movement of the elevator door 111, 131 between the closed position and an open position. The method 300 comprises:
receiving one or more parameters that are descriptive of movement of the elevator door 111, 131 from the closed position towards the open position (block 302);
determining, based on the one or more parameters, the door movement profile that is descriptive of an aspect of movement of the elevator door 111, 131 in relation to the closed position of the elevator door 111, 131; and
detecting compromised operation of the locking mechanism based on one or more characteristics of the door movement profile within a portion that represents a predefined traveling distance in relation to the closed position of the elevator door 111, 131.

Respective operations described with references to blocks 302 to 306 pertaining to the method 300 may be implemented, varied and/or complemented in a number of ways, for example as described in the foregoing and/or in the following with references to the door controller 220, to other elements of the elevator control system 200 and/or to other elements of the elevator system 100.

In case compromised operation of the locking mechanism is detected, the door controller 220 may proceed to taking one or more predefined actions. In this regard, the predefined action(s) may comprise issuing an alert or a maintenance call e.g. via transmitting a message in this regard to the elevator controller 210, which may forward the alert or maintenance call to a further entity in order request necessary maintenance to be carried out in order to restore proper operation of the locking mechanism. As an example, the alert or maintenance call may identify the elevator car 110 and/or the landing 130 for which the compromised operation of the locking mechanism is identified, thereby enabling the elevator controller 220 to take further action in this regard. In another example, additionally or alternatively, in case the compromised operation of the locking mechanism pertains to the car door 111, the predefined action(s) may involve the elevator controller 210 temporarily disabling operation of the elevator car 110.

In another example, the elevator controller 220 may take further action in response to receiving the alert or maintenance call from the door controller 210 of the elevator car 110. In one example, the elevator controller 220 may temporarily disable operation of the elevator car 110 in response to receiving alert or maintenance call suggesting compromised operation of the locking mechanism of the car door 111. In another example, in case the elevator controller 220 receives an alert or maintenance call that pertains to the compromised operation of the locking mechanism of the landing door 131 of the landing 130 (and/or to a respective landing door of another landing of the elevator system 100), the elevator controller 220 may proceed to temporarily disable access to the elevator car 110 and from the elevator car 110 via the landing 130 (and/or via the other landing) in order to ensure safety of the passengers while allowing operation of the elevator car 110 and access to/from the elevator car 110 via other landings, thereby minimizing the downtime (and hence inconvenience to passengers) of the elevator car 110.

In the foregoing, the description refers to the elevator door 111, 131 in singular. However, the description readily generalizes into controlling and monitoring movement of at least one elevator door 111, 131, e.g. a double-door assembly arranged in the elevator car 110 and/or a double door assembly arranged in the landing 130. A double door assembly comprises a first door leaf and a second door leaf that are moveable such that the first and second door leaves are moved away from each other when opening and moved towards each other when closing, where the door driving system 230 may be applied for driving the movement of both door leaves. In such an arrangement, the lock hook assembly 140 may be arranged in the first door leaf and the lock latch 145 may be arranged in the second door leaf (instead of arranging one of the lock hook assembly 140 and the lock latch to the door frame).

In the foregoing, the description refers arranging the lock hook assembly 140 to the elevator door 111, 131 and arranging the lock latch 145 to the door frame (or to another elevator door), whereas in other non-limiting examples the arrangement of the lock hook assembly 140 and the lock latch 145 with respect to the elevator door 111, 131 and the door frame may be the opposite, such that the lock hook assembly 140 is arranged in the door frame while the lock latch 145 is arranged in the elevator door 111, 131.

In the foregoing, the description refers to the lock hook assembly 140 that is rotatable with respect to the lock latch 145, whereas in other non-limiting examples the relative movement between the lock hook assembly 140 and the lock latch 145 may be different. As an example in this regard, the movement of the lock hook assembly 140 may be substantially linear instead of the rotary motion described in the foregoing. In such an arrangement the substantially linear movement has a direction that different from the movement of the elevator door 111, 131, e.g. perpendicular to the movement of the elevator door, thereby providing for rotary movement that enables using the lock hook portion 141 either to engage or disengage the lock latch 145. As another example in this regard, the lock hook assembly 140 may be a stationary component whereas the lock latch 145 may be rotatable with respect to the lock hook assembly 140, thereby providing for movement that enables using the lock hook portion 141 either engage or disengage the lock latch 145. In such an arrangement, the look hook actuation assembly may be referred to as (or replaced with) a lock latch actuation assembly that induces the rotary motion to the lock latch 145 in a manner described in the foregoing for the lock hook actuation assembly inducing rotary motion to the lock hook assembly 140, mutatis mutandis.

Along the lines described in the foregoing, the door controller 220 may comprise or may be provided using one or more computing devices comprising respective one or more processors arranged to execute one or more computer programs to provide at least some aspects of operation of the door controller 220. As an example in this regard, the operation of the door controller 220 may be provided by a door controller apparatus or by an apparatus arranged to operate as the door controller 220. FIG. 6 schematically illustrates some components of an apparatus 400 that may be employed to implement such an apparatus.

The apparatus 400 comprises a processor 410 and a memory 420. The memory 420 may store data and computer program code 425. The apparatus 400 may further comprise communication means 430 for wired or wireless communication with other apparatuses and/or user I/O (input/output) components 440 that may be arranged, together with the processor 410 and a portion of the computer program code 425, to provide the user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus 400 are communicatively coupled to each other via a bus 450 that enables transfer of data and control information between the components.

The memory 420 and a portion of the computer program code 425 stored therein may be further arranged, with the processor 410, to cause the apparatus 400 to perform at least some aspects of operation of the door controller 220 described in the foregoing. The processor 410 is configured to read from and write to the memory 420. Although the processor 410 is depicted as a respective single component, it may be implemented as respective one or more separate processing components. Similarly, although the memory 420 is depicted as a respective single component, it may be implemented as respective one or more separate components, some or all of which may be integrated/removable and/or may provide permanent/semi-permanent/dynamic/cached storage.

The computer program code 425 may comprise computer-executable instructions that implement at least some aspects of operation of the door controller 220 described in the foregoing when loaded into the processor 410. As an example, the computer program code 425 may include a computer program consisting of one or more sequences of one or more instructions. The processor 410 is able to load and execute the computer program by reading the one or more sequences of one or more instructions included therein from the memory 420. The one or more sequences of one or more instructions may be configured to, when executed by the processor 410, cause the apparatus 400 to perform at least some aspects of operation of the door controller 220 described in the foregoing. Hence, the apparatus 400 may comprise at least one processor 410 and at least one memory 420 including the computer program code 425 for one or more programs, the at least one memory 420 and the computer program code 425 configured to, with the at least one processor 410, cause the apparatus 400 to perform at least some aspects of operation of the door controller 220 described in the foregoing.

The computer program code 425 may be provided e.g. a computer program product comprising at least one computer-readable non-transitory medium having the computer program code 425 stored thereon, which computer program code 425, when executed by the processor 410 causes the apparatus 400 to perform at least some aspects of operation of the door controller 220 described in the foregoing. The computer-readable non-transitory medium may comprise a memory device, a record medium or another article of manufacture that tangibly embodies the computer program. As another example, the computer program may be provided as a signal configured to reliably transfer the computer program.

Reference(s) to a processor herein should not be understood to encompass only programmable processors, but also dedicated circuits such as field-programmable gate arrays (FPGA), application specific circuits (ASIC), signal processors, etc.

1. An apparatus for monitoring operation of a locking mechanism applied for securing an elevator door to a closed position, where said monitoring is carried out via monitoring operation of a door driving system arranged for driving movement of the elevator door between the closed position and an open position, wherein the apparatus is arranged to:
receive one or more parameters that are descriptive of movement of the elevator door from the closed position towards the open position;
determine, based on said one or more parameters, a door movement profile that is descriptive of an aspect of movement of the elevator door in relation to the closed position of the elevator door; and
detect compromised operation of the locking mechanism based on one or more characteristics of the door movement profile within a portion thereof that represents a predefined traveling distance in relation to the closed position of the elevator door.

2. The apparatus according to claim 1,
arranged to take predefined action in response to detecting compromised operation.

3. The apparatus according to claim 1, wherein the door driving system comprises an electric motor for moving the elevator door, and
wherein said one or more parameters include respective power consumption of the electric motor at a plurality of door positions within said portion of the door movement profile,
wherein said door movement profile is descriptive of power consumption of said electric motor as a function of door position, and
wherein the apparatus is arranged to detect compromised operation of the locking mechanism in response to detecting power consumption of the electric motor exceeding a predefined power consumption threshold within said portion of the door movement profile.

4. The apparatus according to claim 3, wherein said one or more parameters include respective characteristics of electric current supplied to the electric motor at said plurality of door positions,
wherein said door movement profile is descriptive of electric current supplied to the electric motor as a function of car door position, and
wherein the apparatus is arranged to detect compromised operation of the locking mechanism in response to detecting electric current supplied to the electric motor exceeding a predefined current threshold within said portion of the door movement profile.

5. The apparatus according to claim 3, wherein the electric motor is coupled to the elevator door via a transmission system and wherein the apparatus is configured to track position of the elevator door via tracking position of a predefined component of said transmission system.

6. The apparatus according to claim 5, wherein said predefined component of transmission system comprises a driving belt of a belt drive assembly.

7. The apparatus according to claim 1, wherein the locking mechanism comprises a rotatable lock hook assembly and a lock latch,
wherein the lock hook assembly comprises a lock hook portion that may be applied to selectively engage or disengage the lock latch via rotation of the lock hook assembly,
wherein one of the following applies:
the lock hook assembly is arranged in the elevator door and the lock latch is arranged in an element against which the elevator door is closed in respective positions that enable the lock hook portion engaging the lock latch when the elevator door is brought to the closed position,
the lock hook assembly is arranged in said element and the lock latch is arranged in the elevator door in respective positions that enable the lock hook portion engaging the lock latch when the elevator door is brought to the closed position, and
wherein said element comprises one of the following: a door frame or an adjacent door leaf of a double door assembly.

8. The apparatus according to claim 7, wherein the locking mechanism further comprises a lock hook actuation member arranged;
for rotating the lock hook assembly by a predefined amount in a first direction such that the lock hook portion engages the lock latch in response to moving the elevator door to the closed position, and
for rotating the lock hook assembly by the predefined amount in a second direction that is opposite to the first direction such that the lock latch is disengaged from the lock hook portion in response to moving the elevator door from the closed position towards the open position.

9. The apparatus according to claim 1, wherein said elevator door comprises an elevator car door driven by the door driving system.

10. The apparatus according to claim 1, wherein said elevator door comprises a landing door of a landing of an elevator system,
wherein the landing door is coupled to an elevator car door driven by the door driving system via a door coupler connected to the car door, and
wherein the door coupler is arranged for temporarily coupling the car door to the landing door when the elevator car resides in a landing zone of a landing such that the landing door moves between the open and closed positions together with the car door.

11. The apparatus according to claim 1, wherein said portion of the door movement profile that represents a predefined traveling distance in relation to the closed position of the elevator door comprises one of the following:
a portion that represents a predefined traveling distance starting from a position where the elevator door starts opening,
a portion that represents a predefined traveling distance ending a position where the elevator door starts opening.

12. The apparatus according to claim 1, wherein the door movement profile comprises one of the following:
a door movement profile that is descriptive of an aspect of movement of the elevator door as a function of door position,
a door movement profile that is descriptive of an aspect of movement of the elevator door as a function of time.

13. An elevator car for vertical movement within an elevator shaft of an elevator system between a first landing and at least one further landing, the elevator car comprising:
a car door that is moveable between an open position and a closed position;
a door driving system for driving movement of the car door between the open and closed positions, and
a door controller for controlling operation of the door driving system and for monitoring operation of a locking mechanism applied for securing an elevator door to the closed position, wherein the door controller is arranged to:
receive one or more parameters that are descriptive of movement of the elevator door from the closed position towards the open position,
determine, based on said one or more parameters, a door movement profile that is descriptive of an aspect of movement of the elevator door in relation to the closed position of the elevator door, and
detect compromised operation of the locking mechanism based on one or more characteristics of the door movement profile within a portion thereof that represents a predefined traveling distance in relation to the closed position of the elevator door.

14. The elevator car according to claim 13, wherein said elevator door comprises the car door.

15. The elevator car according to claim 13, further comprising a door coupler connected to the car door for temporarily coupling the car door to a landing door of the first landing when the elevator car resides in a landing zone of the first landing such that the landing door moves between the open and closed positions together with the car door,
wherein said elevator door comprises the landing door coupled to the elevator car door via the door coupler.

16. The elevator car according to claim 14, wherein the door driving system comprises an electric motor for moving the car door,
wherein said one or more parameters include respective power consumption of the electric motor at a plurality of door positions within said portion of the door movement profile,
wherein said door movement profile is descriptive of power consumption of said electric motor as a function of door position, and
wherein the door controller is arranged to detect compromised operation of the locking mechanism in response to detecting power consumption of the electric motor exceeding a predefined power consumption threshold within said portion of the door movement profile.

17. A method for monitoring operation of a locking mechanism applied for securing an elevator door to a closed position, where said monitoring is carried out via monitoring operation of a door driving system arranged for driving movement of the elevator door between the closed position and an open position, wherein the method comprises:
Receiving one or more parameters that are descriptive of movement of the elevator door from the closed position towards the open position;
Determining, based on said one or more parameters, a door movement profile that is descriptive of an aspect of movement of the elevator door in relation to the closed position of the elevator door; and
Detecting compromised operation of the locking mechanism based on one or more characteristics of the door movement profile within a portion thereof that represents a predefined traveling distance in relation to the closed position of the elevator door.

18. A computer program embodied on a non-transitory computer readable medium and comprising computer readable program code configured to cause performing of the method according to claim 17 when said program code is run on one or more computing apparatuses.

19. The apparatus according to claim 2, wherein the door driving system comprises an electric motor for moving the elevator door,
wherein said one or more parameters include respective power consumption of the electric motor at a plurality of door positions within said portion of the door movement profile,
wherein said door movement profile is descriptive of power consumption of said electric motor as a function of door position, and
wherein the apparatus is arranged to detect compromised operation of the locking mechanism in response to detecting power consumption of the electric motor exceeding a predefined power consumption threshold within said portion of the door movement profile.

20. The apparatus according to claim 4, wherein the electric motor is coupled to the elevator door via a transmission system and wherein the apparatus is configured to track position of the elevator door via tracking position of a predefined component of said transmission system.
